(19) United States
(12) Patent Application Publication
(10) Pub. No.: US 2005/0227684 A1
(43) Pub. Date: Oct. 13, 2005

(54) Method for improved predictive reconfiguration of a mobile radio terminal with a configurable transceiver and a corresponding mobile radio terminal

(75) Inventors: Christoph Niedermeier, Munchen (DE); Reiner Schmid, Munchen (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 11/085,594

(22) Filed: Mar. 22, 2005

(30) Foreign Application Priority Data
Mar. 23, 2004 (DE) 10 2004 014 194.0

(51) Int. Cl. H04M 3/00

(52) U.S. Cl. 455/420

(57) ABSTRACT

The invention relates to reconfiguration of a mobile radio terminal with configurable transceiver, where scheduling data for improving a predictive configuration are included, with the scheduling data including information about at least one planned journey and information about at least one desired location and/or time-dependent communication profile for the relevant journey, with a check being made on whether the relevant journey is in principle possible with the desired communication profile on the basis of the existing communication structure and with alternative actions for changes being offered to enable optimally realizable journey data and/or optimally realizable communication profiles with a corresponding prior software download and connection setup to be achieved.

### CLAIM FOR PRIORITY

This application claims priority to German Application No. 10 2004 014 194.0 filed Mar. 23, 2004, which is incorporated herein, in its entirety, by reference.

### TECHNICAL FIELD OF THE INVENTION

The invention relates to a method for predictive reconfiguration of mobile radio terminals with configurable transceivers as well as to a corresponding mobile radio terminal, using location information, routing data and information about the geographical coverage of mobile radio networks.

### BACKGROUND OF THE INVENTION

The present invention relates in particular to the area of “Software-Defined Radio” (SDR). Known SDR terminals have radio transceivers that are software-configurable, which allows a very wide diversity of access technologies (referred to as Radio Access Technology, RAT) to be used. This can involve existing technologies as well as those under development for the future. Examples of such existing systems, or those which are at present in the design phase are
the Universal Mobile Telecommunication System (UMTS), and both the Time Division Duplex (TDD) and also the Frequency Division Duplex (FDD) variants of this system,
the Global System for Mobile communication (GSM),
General Packet Radio Service (GPRS),
WaveLAN,
HyperLAN2 or
Bluetooth.

By exchanging the software which configures the radio transceivers, which contains a description of the wave form, modulation and encoding of the radio signals, the form of communication used with an SDR can be changed (this process is referred to below as reconfiguration). The new configuration software can either already be present in the terminal or is transmitted via a radio connection, stored in the terminal and used in a second step as new configuration software. The transmission and storage of the configuration software is referred to below as the software download.

The use of a wireless Radio Access Technology RAT for transmission can additionally require other variables to be selected as well, which in their totality define a communication channel. These, together with the configured RAT are referred to as the ‘mode’ in the following description.

As a rule a number of such modes will be available, differentiated from each other by different technical features such as bandwidth, delay and reliability of data transmission. The choice of modes can be made manually by the user by a procedure running in the SDR terminal or by external signals. This decision is linked to particular requirements:

As part of the increasing convergence of mobile networks and Internet Protocol IP-based fixed networks, in addition to voice transmission, multimedia data is increasingly being transmitted over mobile radio networks. Different causes can make it necessary to change mode within the course of such a transmission. To ensure that ongoing transmission can be use with interruption, the mode change process must be designed so that the transition from one mode to another appears to the user to be as seamless as possible. If the process can only be undertaken by reconfiguration linked to a software download, a certain amount of time is required to transmit the software required over the radio connection. If this is not available the transmission is either interrupted or ended.

This situation can typically arise in such areas in which a full-coverage infrastructure of a single network operator is not available. Examples of this are the United States or the borders between individual countries. The situation described can arise during a journey through such areas.

Another example is traveling through areas with insufficient network coverage, in which areas without usable modes are traversed.

A possible method for avoiding an interruption or termination of the transmission is based on measuring the quality of the radio connection at intervals. From the data obtained by such measurements and its timing relationships an assessment is made as to whether the SDR is located on the edge of the service area of a mobile radio network. If it is established that this is the case, a new mode is selected in accordance with specific criteria and, if necessary a software download is performed.

This method selects a new mode, taking into account the current local conditions, but does not allow the new mode to be selected so that it is optimized for the rest of the journey, taking account of future expected positions for example.

In the International Patent Application WO 03/017706 A1 (2001P14722) a method is disclosed which describes how this type of optimization can be undertaken on the basis of route planning systems.

### SUMMARY OF THE INVENTION

The present invention discloses a method for predictive reconfiguration of a mobile radio terminal with a configurable transceiver and an corresponding mobile radio terminal, in which a improved predictive reconfiguration is made possible, which avoids gaps in radio coverage, optimizes service quality and service availability and minimizes the costs for wireless data communication.

In one embodiment of the invention, reconfiguration of a mobile radio terminal with configurable transceivers, scheduling data for improvement of a predictive configuration is included, with the scheduling data including location and time-dependent information about at least one relevant planned journey and information about at least one desired location and/or time-dependent communication profile of the relevant journey, with a check being made whether the relevant journey is basically possible with the desired communication profile on the basis of the existing communication structure and with alternative actions for changes being provided, to make possible the implementation of optimum journey data and/or optimum communication profiles with a corresponding prior software download and connection setup.

### BRIEF DESCRIPTION OF THE DRAWINGS

The invention will be explained below in greater detail, with reference to exemplary embodiments and in conjunction with the Figures. The Figures show

FIG. 1 a block diagram of a mobile radio terminal in accordance with the invention.

FIG. 2 a route of a mobile radio terminal through a geographical service area with overlapping modes

### DETAILED DESCRIPTION OF THE INVENTION

In the invention further information extending beyond the route information about the intentions of the user is taken into consideration. The opportunity to do this is provided by the increasing use of electronic planning aids such as electronic organizers or journey planning systems.

In this case it is important that, in addition to the geographical context, i.e. the current and future position of the SDR terminals, the service context or the desired communication profile of the planned journey, i.e. the current and predicted user requirements for the RAT needed as well as the time context as viewed by the user are considered.

In addition the option can be provided for a desired service only to be able to be used if the SDR terminal actively provides the user with suggestions as to how journey plans are to be modified to safeguard the availability of the desired IN services, and changes the journey planning accordingly with the agreement of the user.

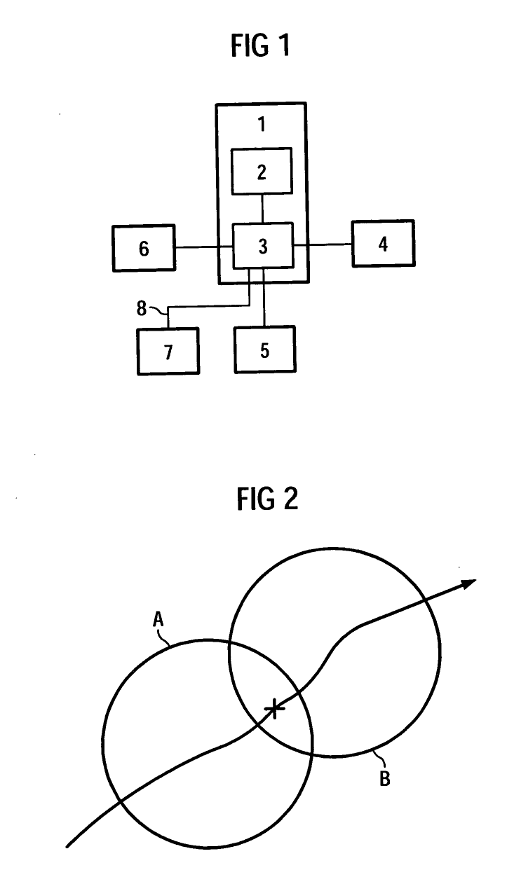

FIG. 1 shows a schematic block diagram to explain the invention, an SDR terminal 1, which communicates over a mobile radio network with a global positioning system 4, a route planning system 5 and a geographical information system 6 and which features a connection 8 to a scheduling system 7. The SDR terminal 1, as well as being equipped with the transceiver 2 already mentioned, has a processing unit 3. The components 1 to 6 and the way in which they operate are known per se from the prior art cited at the start.

With the invention, an additional connection 8 to a scheduling system 7 is established. This can include a Personal Digital Assistant (PDA), or a similar system. In this case this can be both separate from the configurable system , i.e. a self-contained system which is connected via an interface to the SDR system, as well as being integrated into this system itself. The scheduling system 7 in this case provides information about planned usage of the SDR by the user by specifying the type of planned usage. The type of planned usage in this case includes information regarding the characteristics of the services needed within this context, such as whether an audio or video connection is needed. This information includes time as well as type of use, as well as information about the future location of the user and is needed by the SDR system in order to determine, in conjunction with the information about the route and the geographical information about the modes available, whether the planned usages are possible with suitable modes or a desired communication profile for a journey is basically also possible. If this is not the case, different courses of action can be proposed depending on the situation:
1) Changing the route taking into account the communication requirement:
   An adapted journey route or time planning is determined, which makes it possible for the form of communication needed to be available at the right time. This variant is then proposed to the user who can then agree the route of his journey.
   In a preferred embodiment of the invention, one of the following variations is proposed:
      a. Choosing an alternative means of transport:
         This requires interaction with a complex journey planning system.
      b. Introducing pauses into the journey route:
         An alternative variant, if a complex journey planning system is not available or it is not possible to change the method of transport.
2) Shifting the time of the planned communication
   If another opportunity is not available, this is pointed out to the user and he is given the opportunity of shifting the time to allow the desired usage. Under the changed circumstances the modes with the necessary technical features are available.
3) Proposals for changes in the communication, which allow the planned usage.
   Finally, in a further preferred embodiment of the invention, a proposal can be made about changing usage which still allows communication, but possibly with a restricted service scope. Instead of a planned video conference, if for example the user's location makes this impossible, a purely audio conference is proposed.

On the basis of the scheduling information in conjunction with the information from the journey planning system and geographical information about the availability of mobile radio networks, the following can be achieved:
a) An early preparation for future use, by initiating software downloads, to prepare for scheduled usages of an SDR terminal. In particular the software download can be initiated before entering the areas in which the download is not possible. This means that in this case the availability of the modes can be guaranteed even if the user does not prepare for this by manual intervention.
b) An optimization of the choice of modes as regards future scheduled usage: A mode needed for scheduled communication can thus be selected automatically by the terminal in advance to reduce the reconfiguration times.

The characteristics of the system referred to above use a method which determines in each case from the available information whether a scheduled use of the SDR is likely to be possible. Regular checking of the current data as well as checking occasioned by any change to the journey planning data are therefore of further advantage.

The decision about which of the different alternative actions 1)-3) or a)-b) will be chosen can in this case be made in both the journey planning system and also in the reconfigurable terminal.

The user must be included in choosing an alternative means of transport or requiring pauses to be made or rescheduling communication in that users notify the system about whether they agree to the recommended change or not.

The interaction between the components will be illustrated below with reference to a number of selected scenarios which are necessary to achieve the desired improvement in mode selection and optimization of the software download time. The aim here is to achieve optimum mobile radio communication through the SDR by making the best possible choice of communication channel.

The following exemplary embodiments show the execution sequences undertaken in coming to a decision:

a) simple scheduled communication, regular checking of the option of planned use

b) detection of non-availability and initiation of suitable measures

c) Mode optimization

d) Timely software download
Initial situation: The user has defined a communication request for a specific date, e.g. a video conference, by means of his scheduling system. The requirements for the mode to be used can be derived from this, i.e. the technical parameters of a mode such as bandwidth can be determined. From the journey data entered into the scheduling system the predicted location of the user and the planned usage time can be established. By using the information about the geographical spread or the available communication structure (availability of modes at specific locations) it is possible to determine whether, at a specified point in time, the use of a suitable mode is possible. The need for a software download can be determined and this can be initiated at the correct time.

By regular checking using the current position data it is established whether the planning data match the real situation. If there are discrepancies the user can be asked for further information. This includes a correction of the scheduling and the journey planning.

A check is also undertaken if changes are made with regard to scheduling and journey planning which affect the planned communication.
a) If the checking explained in section a) reveals that the required mode is not available, a number of different steps can be taken. The precise selection depends on different parameters here and is not part of this invention. A series of algorithms can be used for this. The different alternatives have been described in 1)-3).
b) The expanded information base through the additional inclusion of key scheduling system further allows numerous optimizations as regards a possible software download required.
   Here are a number of examples: By timely prior initiation of the software downloaded the availability of the software components needed can be ensured. The costs for download can be minimized by selecting a suitable download channel and a suitable time. For example a software component needed could be supplied during the night before the rescheduled used in order to make use of favorable tariffs for download at nights, or the high-speed networks in hot-spots at airports or stations could be used for the download.
   c) The software download can be initiated in good time. A specific scheduled use is analyzed at the earliest possible point in time, i.e. when all the data required in this connection is present, as regards the required characteristics of the mode to the used. If a vertical handover is required and the software needed for this is not available on the terminal, a software download is performed at a suitable point in time. The selection of this point in time is dependent on the route planning, the geographical spread of the mobile radio network as well as the planned usages. The best time is the time at which the adverse effects on the active services are as little as possible and the software download can simultaneously be performed as cheaply as possible. In addition the point in time of the software download should clearly differ from the point of the intended handover so that the risk of not being able to complete the download as a result of faults is minimized.

A series of advantages are produced by the invention:

A simplified transparent access to use of mobile radio networks is made possible for the user in particular advantageous mobile radio terminals can be built by using the method. A significant technical advantage of the method is the provision of a defined quality of access technology at a defined point in time at a defined location. The procedure illustrated here, when compared to previously known methods, allows significantly better account to be taken of the journey and scheduling of the user and thereby the availability of a mobile communication option which possesses sufficient properties to be securely guaranteed. For better control of mode selection, as well as the location context, both the service contact, i.e. the type of services used or intended for use and also the timing context, i.e. information about future planned usages in conjunction with journey planning is used . An example of this is taking account of planned events, as can be recorded by the electronic appointment calendar for example. Above and beyond the optimization of the mode selection, alternatives can also be proposed to the user which require a change to the route of the journey or a change in timing of the journey sequence. Such a proposal might be for example that, in order to conduct a video conference at a defined point in time, a break in the journey at a specific location is necessary since only there is the necessary bandwidth available or only there can it be obtained at an acceptable price. In addition the scheduling can already have been taken into account during route planning by taking into consideration the geographical availability of the required mobile radio networks. Since the planning is subjected to checking at regular intervals, deviations from the planned journey sequence or the scheduling are detected and compensated for by suitable measures if necessary.

1. A method for reconfiguration of a mobile radio terminal with a configurable transceiver using scheduling data, comprising:
transferring scheduling data in a form of location and time-independent information about at least one planned journey and information about at least one desired location and/or time-dependent communication profile for a relevant journey from the scheduling system;
determining communications structure information about a geographical service area and availability of mobile networks from a geographical information system for the relevant journey;
checking whether the relevant journey is in principle possible with a desired communication profile based on an existing communication structure depending on a location and/or timing conditions;
offering, provided the desired communication profile is essentially possible for the journey, alternative actions with location and/or timing changes such that the communication profile is achieved or else a change to the desired communication profile is proposed;
defining, after selection of the alternative actions, journey data and a communication profile which can be implemented are defined; and
implementing, in accordance with the journey data that can be implemented and the communication profile that can be implemented, a time and execution of a transfer of suitable software sections and/or configuration data on the mobile terminal for its reconfiguration with regard to the communication channel to be changed and/or the access technology to be changed at the desired point in time.

2. The method according to claim 1, wherein the alternative actions are selected from at least one of:
a) an alternative choice of method of transport,
b) an introduction of at least one specific pause,
c) a shifting of a least one that communication time, and
d) a change to the desired communication profile is selected.

3. The method in accordance with claim 1, wherein the desired communication profile includes location and/or timing information and characteristics of the desired types of communication or communication characteristics.

4. The method according to claim 3, wherein the characteristics include upper quality, availability and/or price limits.

5. The method according to claim 1, wherein the scheduling system is interrogated at regular intervals to determine a current state or for changes and in which, in a case of changes, a corresponding transfer of the latest scheduling data is undertaken in the mobile terminal.

6. The method according to claim 1, wherein during the relevant journey the actual location at a given time is determined by a global positioning system and the journey data and/or communication profile that can be implemented are corrected accordingly.

7. A mobile radio terminal with a configurable transceiver, comprising:
a scheduling system to transfer scheduling data in a form of location and time-dependent information about at least one planned a journey and information about at least one desired location and/or time-dependent communication profile for the relevant journey to a processing unit of the mobile radio terminal;
a geographical information system to determine, for a relevant journey, communication infrastructure information about a geographical service area and availability of mobile radio networks; and
a processing unit to check whether the relevant journey is possible with a desired communication profile based on an existing communications structure depending on location and/or timing conditions, wherein
provided the desired communications profile is possible for the journey, alternative actions with the location and/or timing changes are offered such that the communication profile is achieved or else a change of the desired communication profile is proposed,
after selection of the alternative actions, journey data that can be implemented and a communication profile that can be implemented are determined,
in accordance with the journey data which can be implemented and the communication profile which can be implemented, a time and execution of a transfer of suitable software sections and/or configuration data on the mobile terminal for a reconfiguration with regard to the communication channel to be changed and/or the access technology to be changed is undertaken at a desired point in time.
